(19) United States
(12) Patent Application Publication
(10) Pub. No.: US 2015/0114312 A1
(43) Pub. Date: Apr. 30, 2015

(54) Adjustably Fitting Animal Garment

(71) Applicant: Stephanie Cacopardo, New Market, MD (US)

(72) Inventor: Stephanie Cacopardo, New Market, MD (US)

(21) Appl. No.: 14/504,425

(22) Filed: Oct. 2, 2014

Related U.S. Application Data
(60) Provisional application No. 61/896,910, filed on Oct. 29, 2013.

(51) Int. Cl. A01K 13/00

(52) U.S. Cl. CPC A01K 13/006
USPC 119/850

(57) ABSTRACT

Disclosed is a garment for pets. The present invention includes a poncho-style coat for pets. The coat includes a chest section extending perpendicularly from a back section having a first end opposite a second end, and a rear end. In one embodiment, the rear end further includes a flap having a first end and a second end, wherein the first end and the second end of the flap are adapted to cover an upper portion of a pet's hind legs. The first end and the second end of the back section are adapted to fold downward to cover the back, sides, and abdomen of the pet. The chest section is adapted to fold downward to cover the chest and abdomen of the pet. The chest section and the first end and the second end of the back section overlap, and are removably secured together by means of fasteners.

### CROSS REFERENCE TO RELATED APPLICATION

This application claims the benefit of U.S. Provisional Application No. 61/896,910 filed on Oct. 29, 2013. The above identified patent application is herein incorporated by reference in its entirety to provide continuity of disclosure.

### BACKGROUND OF THE INVENTION

1. Field of the Invention

The present invention relates to a garment for animals. More specifically, the present invention pertains to an improved poncho-style coat that is easy to don, and in one embodiment, the present invention comprises a T-shaped poncho that can be wrapped around a dog to cover the dog's back, chest, and abdomen.

While many animals have sufficient layers of fur to protect themselves from cold weather, some animals have lighter layers of fur, and are not genetically suited to the environments in which they are transplanted. This is particularly true for dogs. Smaller, light bodied breeds, toy breeds, and breeds that naturally have very short or thin hair coats are unable to maintain proper internal body temperature in cold weather. As a result, these dogs may be extremely uncomfortable with the winter temperatures.

These dogs can benefit from wearing clothing or garments when they need to go outside and are exposed to cold weather. Conventional garments for pets, however, generally cover only the back of the pet, and leave the chest and abdomen area completely or partially exposed. In this way, the chest and abdomen area of the pet are unprotected from the cold weather, and the dog can remain uncomfortable because he or she is not properly shielded under the garment.

Additionally, conventional garments for pets comprise narrow sleeves or openings for a pet's legs. Many pets do not feel comfortable putting their legs through a narrow opening, however. It is especially difficult for pets with leg sprains, strains, and ligament injuries. Accordingly, pet garments with leg openings can be disadvantageous and inconvenient for many pet owners because it is difficult to place the pet's legs through the narrow leg openings.

The present invention provides a garment for pets. The device includes a poncho-style coat for a pet, and in one embodiment, it is adapted to be worn by a dog. The coat comprises a chest section and a back section, wherein the two sections form a T-shape when viewed from the top. The coat further comprises an opening for a pet's head, disposed between the chest section and the back section. The back section comprises a first end opposite a second end, and a rear end. The back section is configured so that when the first end and the second end are folded downward, the back section completely covers the pet's back, sides, and abdomen. The chest section can also be folded downward to cover the pet's chest, and is dimensioned to overlap the first end and the second end of the back section at the pet's abdomen. In the exemplary embodiments, the first end and the second end of the back section and the chest section are removably secured together by means of hook and loop fasteners.

Moreover, the present invention comprises different embodiments for male and female pets. The back section of the embodiment for male pets is configured so that it does not contact the male pets' genitalia. Accordingly, the length of the back section of the embodiment for male pets is less than the length of the back section of the embodiment for female pets. The embodiment for female pets further comprise a flap attached to the rear end of the back section. The flap is adapted to cover an upper portion of the pet's hind legs to provide additional warmth.

The primary advantage of the present invention is the donning method associated with the coat of the present invention. The construction of the present invention allows the coat to be put on the pet without requiring the pet's legs to be inserted through sleeves or a similar opening for limbs. Thus, the present invention can be conveniently put on or taken off of an animal with sprains, strains, and ligament injuries.

2. Description of the Prior Art

Devices have been disclosed in the prior art that claim garments for pets. These include devices that have been patented and published in patent application publications. Some of these devices disclose an ornamental design for a lamb coat that includes a poncho style cover with a back cover, abdomen cover, and strap that secures the device in position. Other devices disclose a pet coat that wraps over the back of a pet and is secured in position with a strap that encircles the torso of the pet. These devices, however, do not disclose a poncho style garment with hook and loop fasteners that are sewn into the sides to secure the garment in a closed position. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Design Pat. No. D613001 to OBrien, U.S. Pat. No. 6,477,988 to Burnett, and U.S. Design Pat. No. D228926 to Bennett each disclose a coat for animals. These coats generally comprise a back section having a front end and a back end, wherein the front end comprises a chest section extending downward at an angle. The chest section comprises an adjustable strap that wraps around the back section.

The foregoing devices, however, are limited in the fact that none of the devices cover the dog's abdomen. The present invention comprises a poncho-style coat having a chest section that can removably connect to the sides of the back section, wherein the back section is configured to cover the back, sides, and abdomen of a dog. Thus, the coat can cover the dog's back and extend downward to cover the dog's abdomen. In this way, the present invention provides more body coverage to help retain body heat.

U.S. Pat. No. 7,121,231 to Benefiel discloses a dog coat that has a rectangular back section that is adapted to be draped over the dog's back. The back section comprises side ends, a front end, and a back end. Each of the side ends comprise a strap thereon. The straps can be removably secured by means of hook and loop fasteners. The front end comprises a pair of neck straps that can be removably secured by means of hook and loop fasteners. Thus, the device of Benefiel does not comprise a T-shape, and does not comprise an opening for the dog's head. Additionally, the device of Benefit is not configured to cover the dog's chest and abdomen.

U.S. Published Patent Application Number 2009/0235871 to Andreas discloses a towel for drying pets. The device comprises a rectangular towel with a first opening for the pet's head and a second opening for the pet's tail. The purpose and design of the device of Andreas therefore differ from the present invention in that the present invention discloses a garment for pets.

U.S. Published Patent Application Number 2011/0155077 to Hurwitz discloses a disposable rain gear for pets. The device comprises a generally X-shaped cover, and in one embodiment, comprises a removably attached hood. The device of Hurwitz differs from the present invention in that the device of Hurwitz relates to disposable rain gear, and is not constructed to help pets retain their body heat and protect the pets during cold weather. The present invention discloses a pet garment that is composed of insulating material such as fleece, wool, and other suitable material or fabric. Thus, the present invention helps to prevent exposure to the cold weather.

Finally, U.S. Pat. No. 2,400,781 to Priour discloses a coat for animals comprising a tubular member having an opening for the pet's head, and a plurality of openings for the pet's legs. The device of Priour, therefore requires the pet to insert his or her legs through the leg openings to don the coat. Thus, Priour teaches away from a garment for pets having no leg openings. The present invention comprises an opening for the pet's head, a chest section, and a back section. After the pet's head is inserted through the opening, the chest section can fold downward and toward the back section to connect to the sides of the back section, creating gaps in which the pet's legs are placed. In this way, the present invention does not require the pet's legs to be inserted through any openings.

The devices disclosed in the prior art have several known drawbacks. These devices are limited in that none of the foregoing devices are constructed to cover the pet's back, chest, and abdomen. The present invention overcomes these limitations by disclosing a poncho-style coat having a generally T-shape. The coat comprises a chest section that is substantially perpendicular to a back section, and an opening for the pet's head therebetween. The back section is dimensioned to cover the back, sides, and abdomen of a dog.

It is therefore submitted that the present invention is substantially divergent in design elements from the prior art, and consequently it is clear that there is a need in the art for an improvement to garments for pets. In this regard, the instant invention substantially fulfills these needs.

### SUMMARY OF THE INVENTION

In view of the foregoing disadvantages inherent in the known types of garments for pets now present in the prior art, the present invention provides a new and improved adjustably fitting animal garment wherein the same can be utilized for protecting pets from cold weather and helping pets retain their body heat.

It is therefore an object of the invention to provide a new and improved adjustably fitting animal garment that has all of the advantages of the prior art and none of the disadvantages.

Another object of the present invention is to provide a new and improved adjustably fitting animal garment that is convenient to don and doff.

Yet another object of the present invention is to provide a new and improved adjustably fitting animal garment comprising a poncho-style garment having a chest section that is perpendicular to a back section, wherein the chest section can removably connect to a back section to form gaps for a pet's legs.

Still yet another object of the present invention is to provide a new and improved adjustably fitting animal garment that is suitable to be worn by male or female pets, depending upon embodiment.

Still yet another object of the present invention is to provide a new and improved adjustably fitting animal garment that is composed of insulating material.

Still yet another object of the present invention is to provide a new and improved adjustably fitting animal garment wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of a first embodiment of the present invention.

FIG. 2 shows a bottom view of the first embodiment of the present invention.

FIG. 3 shows a perspective view of a second embodiment of the present invention.

FIG. 4 shows a view of the present invention as being put on a dog.

FIG. 5 shows a view of the present invention as worn by a dog.

### DETAILED DESCRIPTION OF THE INVENTION

References are made herein to the attached drawings. Like reference numerals are used throughout the drawings to depict like or similar elements of the adjustably fitting animal garment. For the purposes of presenting a brief and clear description of the present invention, the preferred embodiment will be discussed as used to protect pets from cold weather and help pets retain their body heat. The figures are intended for representative purposes only and should not be considered to be limiting in any respect.

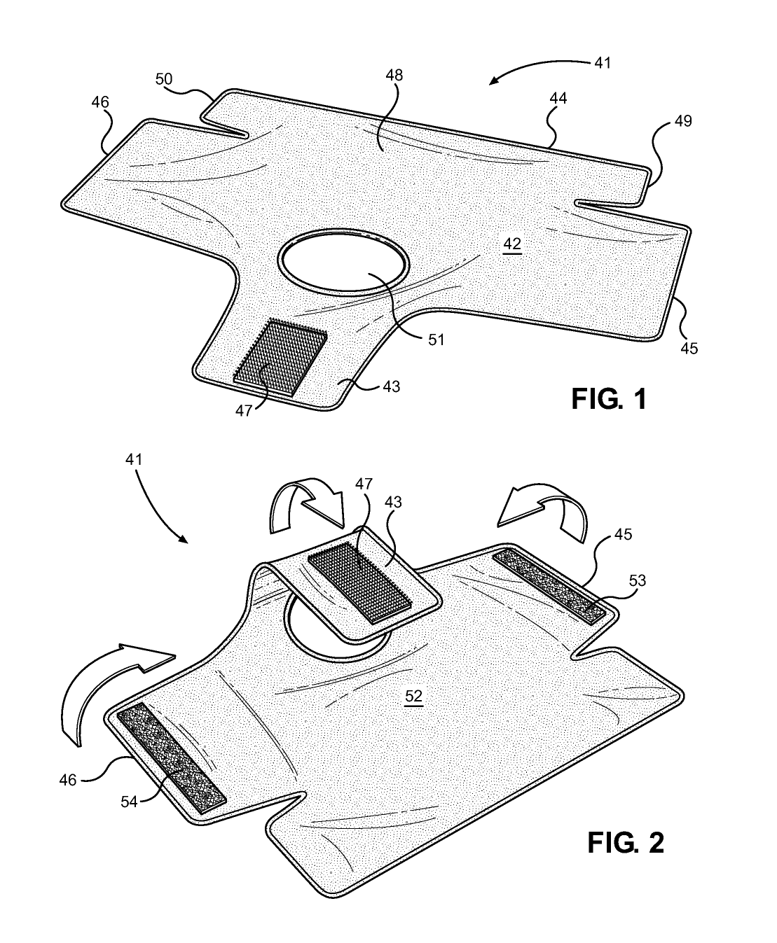

Referring now to FIGS. 1 and 2, there are shown top and bottom perspective views of the present invention. The present invention comprises a coat 41 having an outer surface 42 that is coextensive with an inner surface 52, defining a perimeter. The coat 41 further comprises a chest section 43, a back section, and a circular head opening 51 disposed therebetween. The chest section 43 is preferably integral to the back section so that the coat is unitary in structure. The chest section 43 protrudes perpendicularly outward from the back section, so that when the coat 41 is viewed from top, it generally forms a T-shape.

The chest section 43 is directly aligned with the head opening 51 on the coat. The chest section 43 is configured to extend vertically from the front of the pet's neck toward the pet's abdomen, and extend horizontally between the two front legs of the pet. In the illustrated embodiment, the chest section 43 comprises a strip of hook fasteners 47 on the outer surface 42 thereof. In this way, the hook fasteners 47 do not directly contact the pet and is prevented from rubbing thereagainst, which could cause irritation.

The back section comprises a first end 45 opposite a second end 46, and a rear end 44, wherein the rear end 44 may be straight or rounded, depending upon embodiment. The back section is dimensioned so that it extends from the back of the pet's neck and terminates short of the pet's tail, thereby substantially covering the pet's back. Additionally, the back section is dimensioned so that the distance between the first end 45 and the second end 46 is of sufficient length for the back section to cover the pet's back, sides, and abdomen. Each of the first end 45 and the second end 46 comprise a strip of loop fasteners 53, 54 on the inner surface 52 thereof.

The first end 45 and the second end 46 can be folded downward toward each other; and the chest section 43 can be folded downward toward the back section. In this way, the chest section 43, the first end 45, and the second end 46 are overlapped near or at the pet's chest and abdomen. Thereafter, the loop fasteners 53, 54 on the first end 45 and the second end 46 can be secured to the hook fasteners 47 on the chest section 43. The width of the strip of hook fasteners 47 is approximately twice the width of each of the strip of loop fasteners 53, 54. In this way, both strips of loop fasteners 53, 54 can be removably secured to the hook fasteners 47 in a side-by-side orientation.

In the illustrated embodiment, the back section further comprises a flap 48 having a first end 49 and a second end 50. The first end 49 and the second end 50 of the flap 48 are separated from the first end 45 and the second end 46 of the back portion by a V-shaped slit disposed therebetween. The distance between the first end 49 and the second end 50 of the flap 48 is less than the distance between the first end 45 and the second end 46 of the back section. The first end 49 and the second end 50 of the flap is adapted to cover the upper portion of the pet's hind legs.

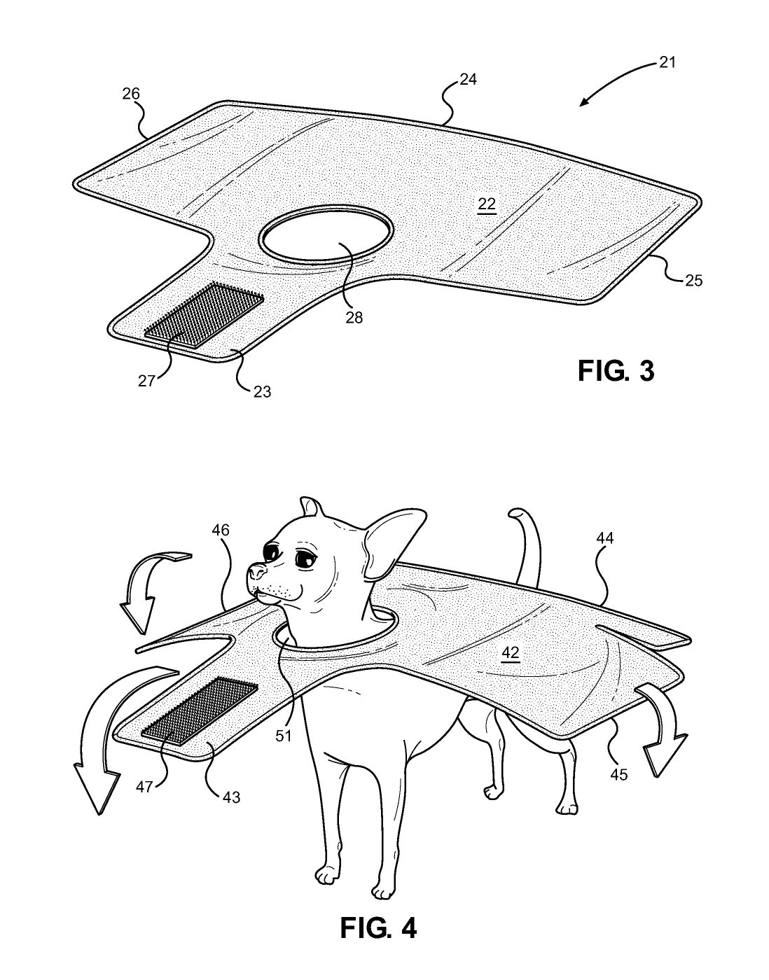

Referring now to FIG. 3, there is shown another embodiment of the present invention. The illustrated embodiment of the coat 21 comprises an outer surface 22 that is coextensive with an inner surface. Similar to the first embodiment, the coat 21 comprises a centrally located chest section 23 that is perpendicular to the back section, generally forming a T-shape. The chest section 23 is integral to the back section so that the coat 21 is unitary in structure. The coat further comprises a circular opening 28 for receiving a pet's head therethrough. The circular opening 28 is aligned with the chest section 23 so that the chest section 23 can cover the pet from the front of the pet's neck to the pet's abdomen in a straight configuration.

The chest section 23 is generally rectangular and comprises a strip of hook fasteners 27 thereon. The hook fasteners 27 are adapted to removably attach to the strips of loop fasteners disposed on the inner surface at the first end 25 and the second end 26 of the back section. The back section further comprises a rear end 24, wherein the rear end 24 is curved or straight, depending upon embodiment.

The back section is dimensioned so that it extends from the back of the pet's neck and terminates near the pet's hips. The distance between the opening 28 and the rear end 24 of the illustrated embodiment is less than the distance between the opening 51 and the rear end 44 of the first embodiment. Accordingly, the width of the first and second ends 25, 26 of the second embodiment is also less than the width of the first and second ends 45, 46 of the first embodiment. In this way, the illustrated embodiment is better suited for male pets because the back section of the illustrated embodiment does not contact the male pets' genitalia. Conversely, the first embodiment of the present invention is better suited for female pets because the back section of the first embodiment is longer, and thereby more likely to directly contact the male genitalia of a pet on which the coat is worn.

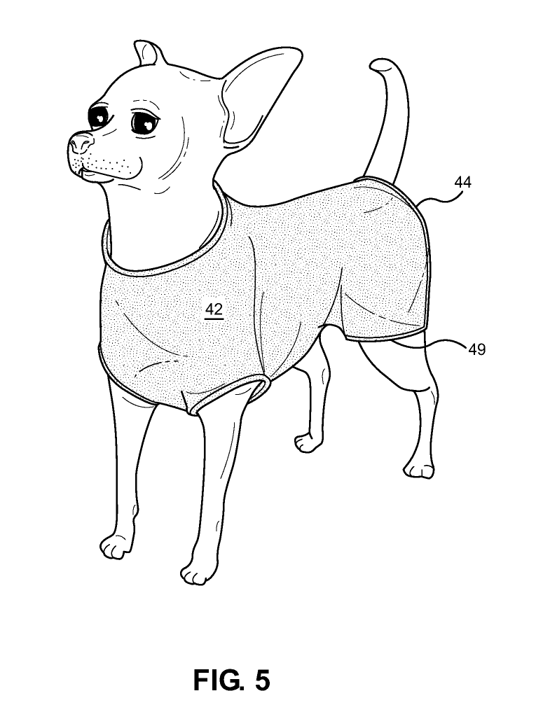

Referring now to FIGS. 4 and 5, there are shown a view of the present invention being put on a dog and a view of the present invention as worn by the dog, respectively. The present invention may be composed of insulating material, such as fleece, wool, or other suitable material or fabric. In some embodiments, the coat may comprise multiple layers, such as an insulating layer and a waterproof barrier, among others. Additionally, the coat may be stretchable so that the opening 51 may be slightly stretched when placed over the dog's head. The dog's head is placed through the opening 51 so that the inner surface of the coat directly contacts the dog and the outer surface 42 faces away from the dog. Additionally, the chest section 43 is placed in front of the dog's chest and the rear end 44 is placed in front of the dog's tail. The chest section 43 is folded downward and positioned over the dog's chest, between the dog's front two legs.

The first end 45 and the second end 46 of the back section is also folded downward so that they cover the sides of the dog and overlap with the chest section 43. The first end 45, the second end 46, and the chest section 43 fold around the pet's front legs, so that the pet's front legs do not need to be inserted into a sleeve or an opening. The first end 45, the second end 46, and the chest section 43 are removably secured together by means of hook fasteners 47 and loop fasteners. In other embodiments, however, other fasteners, such as snap fasteners may be used.

The first end 49 and the second end of the flap are also folded downward, covering the upper portion of the pet's hind legs. The first end 49 and the second end of the flap are separated from the first end 45 and the second end 46 of the back section by a pair of V-shaped slits. In this way present invention is constructed to prevent bunching when it is worn by a pet. Additionally, the present invention may comprise dart stitching on opposing sides where the chest section meets the back section, or where the pet's shoulders would be located when the coat is worn. Dart stitching allows the coat to be tailored to the pet's body shape.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustably fitting animal garment, comprising:
a coat having a chest section that is perpendicular and integral to a back section, wherein said back section includes a first end opposite a second end, and a rear end;
a head opening disposed between said chest section and said back section;
hook fasteners on an outer surface of said chest section;
loop fasteners on an inner surface of each of said first end of said back section and said second end of said back section;
wherein said hook fasteners and said loop fasteners can removably engage.

2) The animal garment of claim 1, wherein said rear end of said back section comprises a flap having a first end opposite a second end;
wherein said first end of said flap and said second end of said flap extend toward an upper portion of a pet's hind legs.

3) The animal garment of claim 2, wherein a distance between said first end of said flap and said second end of said flap is less than a distance between said first end of said back section and said second end of said back section

4) The animal garment of claim 1, wherein said chest section and said back section form a T-shape.

5) The animal garment of claim 1, wherein said coat is composed of fleece fabric.

6) The animal garment of claim 1, wherein said chest section is centrally located on said back section.

7) The animal garment of claim 1, wherein said head opening is circular.

8) The animal garment of claim 1, wherein said coat is unitary in construction.
